(19) United States
(12) Patent Application Publication
(10) Pub. No.: US 2021/0139777 A1
(43) Pub. Date: May 13, 2021

(54) LIQUID-CRYSTAL MEDIUM

(71) Applicant: MERCK PATENT GMBH, Darmstadt (DE)

(72) Inventors: Michael WITTEK, Erzhausen (DE); Dagmar KLASS, Darmstadt (DE)

(73) Assignee: MERCK PATENT GMBH, Darmstadt (DE)

(21) Appl. No.: 16/618,653

(22) PCT Filed: May 28, 2018
(86) PCT No.: PCT/EP2018/063868

§ 371 Date: Dec. 2, 2019

(30) Foreign Application Priority Data
May 30, 2017 (DE) 10 2017 005 413.4

(51) Int. Cl. C09K 19/30; C09K 19/18; C09K 19/34

(52) U.S. Cl. CPC C09K 19/3003; C09K 19/3066; C09K 2019/0466; C09K 19/3491; C09K 19/18

(57) ABSTRACT

The present invention relates to a liquid-crystalline medium having a clearing point of 120° C. or more, comprising one or more compounds selected from the group of the compounds of the formulae IA, IB, IC, ID and II

[chemical structure]

in which the groups and parameters occurring have the meanings indicated in Claim 1, in a total concentration of 65% or more, and to the use thereof for electro-optical purposes, in particular for liquid-crystal light valves for use in lighting devices for motor vehicles, to liquid-crystal light valves containing this medium, and to lighting devices based on liquid-crystal light valves of this type.

The present invention relates to a liquid-crystalline medium and to the use thereof for electro-optical purposes, in particular for liquid-crystal light valves for use in lighting devices for vehicles, to liquid-crystal light valves containing this medium, and to lighting devices based on liquid-crystal light valves of this type.

Liquid crystals are used, in particular, as dielectrics in display devices, since the optical properties of such substances can be influenced by an applied voltage. Electro-optical devices based on liquid crystals are known to the person skilled in the art and can be based on various effects. Devices of this type are, for example, TN cells having a twisted nematic structure or STN (“super-twisted nematic”) cells. Modern TN and STN displays are based on an active matrix of individually addressable liquid-crystal light valves (the pixels) with integrated red, green and blue coloured filters for additive generation of the colour images.

The electro-optical effects utilised in liquid-crystal displays have recently also been used for other applications. DE 19910004 A1 describes LCD screens as shade for adjusting the brightness distribution of lighting devices for motor vehicles as desired, by means of which the brightness distribution is to be adapted to the driving situation in a flexible manner.

Adaptive lighting systems of this type for motor vehicles (adaptive front lighting system, AFS) generate headlamp light which is adapted to the particular situation and ambient conditions and are capable of reacting, for example, to the light and weather conditions, the movement of the vehicle or the presence of other road users, in order to illuminate the environment constantly and optimally and avoid adversely affecting other road users. U.S. Pat. No. 4,985,816 discloses, for example, components in which a spatial light modulator in the form of a liquid-crystal display (LCD) plate consisting of a matrix of light-transmitting elements, analogously to the pixels of a liquid-crystal display, generates electrically switchable, complete or partial shading of the light cone with the aim of avoiding or reducing dazzling of the drivers of oncoming vehicles. Spatial light modulators of this type are, as already mentioned, also known as liquid-crystal light valves. Owing to the similar way of functioning as in projectors, the term projector-type vehicle lighting is also used. The image information for controlled shading of the light cone is preferably supplied here by a digital camera.

A liquid-crystal light valve in the sense of the present invention may include a single area for modulation of the light or a matrix of a multiplicity of identical or different part-areas corresponding to the pixels of a liquid-crystal display. The area or part-area can have been designed to be transmissive or reflective. A matrix of liquid-crystal light valves thus represents a special case of a monochrome matrix liquid-crystal display or can be regarded as a part thereof.

In a preferred embodiment, the lighting device according to the invention comprises one or more liquid-crystal light valves of the liquid-crystal display type.

In a reflective embodiment, the lighting device according to the invention is a transmissive device and comprises one or more liquid-crystal light valves of the LCoS (liquid crystal on silicon) type.

A lighting device in the sense of the invention is, in particular, an AFS or part of an AFS. A lighting device in the sense of the invention serves, in particular, for the illumination of an area in front of a vehicle or motor vehicle.

Vehicles in the sense of the invention are very generally means of transport, such as, for example, but not restricted to, aircraft, ships, and land vehicles, such as automobiles, motorcycles and bicycles, as well as rail-bound land vehicles, such as, for example, locomotives.

Motor vehicle in the sense of the invention is, in particular, a land vehicle which can be used individually in road traffic. Motor vehicles in the sense of the invention are, in particular, not restricted to land vehicles having a combustion engine.

In the liquid-crystal light valve disclosed in the above-mentioned U.S. Pat. No. 4,985,816, a TN cell is used as optical modulation element, which displays pixels in accordance with the desired brightness profile of the vehicle lighting, where, for example, an addressing voltage is applied to the TN liquid-crystal for modulation (control) of the degree of transmission of a pixel. Owing to the polarisers that are necessary there, only about half of the light of the light source can be utilised. An alternative, which is likewise based on a TN cell, which enables more than only half of the light of the light source of the lighting device to be rendered useful is disclosed in DE 10 2013 113 807 A1. In this, the light is divided into two part-beams having planes of polarisation perpendicular to one another by means of a polarising beam splitter and guided through two separate liquid-crystal elements which can be switched separately from one another.

Lighting devices of this type are distinguished by comparatively high operating temperatures of typically 60-80° C., which makes particular demands of the liquid-crystal media used: the clearing points must be higher than 120° C., preferably higher than 140° C., and, owing to the strong exposure to light, these media must have particularly high light stability. This may under certain circumstances be favoured, for example, by the use of materials having extremely low birefringence. The liquid-crystal materials must, in addition, have good chemical and thermal stability and good stability to electric fields. Furthermore, the liquid-crystal materials should have low viscosity and give rise to relatively short addressing times, the lowest possible operating voltages and high contrast in the cells.

Furthermore, they should have a suitable mesophase, for example for the above-mentioned cells a nematic or cholesteric mesophase, at usual operating temperatures, i.e. in the broadest possible range below and above room temperature, preferably from −40° C. to 150° C. Since liquid crystals are generally used in the form of mixtures of a plurality of components, it is important that the components are readily miscible with one another. Further properties, such as the electrical conductivity, the dielectric anisotropy and the optical anisotropy, have to meet different requirements depending on the cell type and area of application. For example, materials for cells having a twisted nematic structure should have positive dielectric anisotropy and low electrical conductivity.

For example, media having large positive dielectric anisotropy, broad nematic phases, relatively low birefringence, very high specific resistance, good light and temperature stability and low vapour pressure are desired for light valves in matrix liquid-crystal displays having integrated non-linear elements for switching individual pixels (MLC displays). Matrix liquid-crystal displays of this type are known, and the design principle can also be used for the lighting device according to the invention.

Examples of non-linear elements which can be used to individually switch the individual pixels are active elements (i.e. transistors). The term “active matrix” is then used, where a distinction can be made between two types:
1. MOS (metal oxide semiconductor) or other diodes on silicon wafers as substrate.
2. Thin-film transistors (TFTs) on a glass plate as substrate.

The use of single-crystal silicon as substrate material restricts the display size, since even modular assembly of various part-displays results in problems at the joints.

In the case of the more promising type 2, which is preferred, the electro-optical effect used is usually the TN effect. A distinction is made between two technologies: TFTs comprising compound semiconductors, such as, for example, CdSe, or TFTs based on polycrystalline or amorphous silicon. Intensive work is being carried out worldwide on the latter technology.

The TFT matrix is applied to the inside of one glass plate of the display, while the other glass plate carries the transparent counterelectrode on the inside. Compared with the size of the pixel electrode, the TFT is very small and has virtually no adverse effect on the image.

The TFT displays and corresponding light valves for lighting devices usually operate as TN cells with crossed polarisers in transmission and are backlit.

The term MLC displays here encompasses any matrix display with integrated non-linear elements, i.e., besides the active matrix, also displays with passive elements, such as varistors or diodes (MIM=metal-insulator-metal).

Besides problems regarding the angle dependence of the contrast and the response times, difficulties also arise in MLC displays due to insufficiently high specific resistance of the liquid-crystal mixtures [TOGASHI, S., SEKIGUCHI, K., TANABE, H., YAMAMOTO, E., SORIMACHI, K., TAJIMA, E., WATANABE, H., SHIMIZU, H., Proc. Eurodisplay 84, September 1984: A 210-288 Matrix LCD Controlled by Double Stage Diode Rings, pp. 141 ff, Paris; STROMER, M., Proc. Eurodisplay 84, September 1984: Design of Thin Film Transistors for Matrix Addressing of Television Liquid Crystal Displays, pp. 145 ff, Paris]. With decreasing resistance, the contrast of an MLC display deteriorates, and the problem of after-image elimination may occur. Since the specific resistance of the liquid-crystal mixture generally drops over the life of an MLC display owing to interaction with the interior surfaces of the display, a high (initial) resistance is very important in order to obtain acceptable lifetimes. In particular in the case of low-volt mixtures, it was hitherto impossible to achieve very high specific resistance values. It is furthermore important that the specific resistance exhibits the smallest possible increase with increasing temperature and after heating and/or exposure to light. This is also relevant on use of light valves in lighting devices for vehicles, since the liquid crystal therein is subjected to high temperatures and light levels, and a low specific initial resistance and a rapid increase in the specific resistance on exposure generally correlates with low long-term stability.

The low-temperature properties of the mixtures from the prior art are also particularly disadvantageous. It is required that no crystallisation and/or smectic phases occur, even at low temperatures, and the temperature dependence of the viscosity is as low as possible. The MLC displays from the prior art thus do not satisfy the requirements for use in lighting devices.

There is thus still a great demand for liquid-crystal mixtures having very high specific resistance at the same time as a large working-temperature range and high light stability.

In the case of liquid-crystal light valves for lighting devices for vehicles, media are desired which facilitate the following advantages in the cells:
extended nematic phase range (in particular to high temperatures)
stable on storage, even at low temperatures
switchability at low temperatures
increased light stability.

For alignment of the above-mentioned liquid-crystalline media, polyimide alignment layers are usually provided. These may represent a source of impurities, which becomes evident, in particular, at the relatively high temperatures that occur during operation of lighting devices for vehicles and may result, inter alia, in poor resistivity of the liquid-crystalline medium.

There are already a number of approaches for the production of liquid-crystal displays that manage without a polyimide alignment layer, including inorganic alignment layers (see, for example, H. K. Baik et al., Langmuir 2005, 21, 11079-11084; J. B. Kim et al., Adv. Mater. 2008, 20, 3073-3078). Displays having alignment layers of this type have a homeotropic alignment of the liquid-crystal molecules and are therefore based on liquid-crystalline media having negative dielectric anisotropy.

Liquid-crystalline media having negative dielectric anisotropy are known, in particular, from the use in electro-optical displays having active-matrix addressing based on the ECB effect.

The principle of electrically controlled birefringence, the ECB effect or also DAP (deformation of aligned phases) effect, was described for the first time in 1971 (M. F. Schieckel and K. Fahrenschon, “Deformation of nematic liquid crystals with vertical orientation in electrical fields”, Appl. Phys. Lett. 19 (1971), 3912). This was followed by papers by J. F. Kahn (Appl. Phys. Lett. 20 (1972), 1193) and G. Labrunie and J. Robert (J. Appl. Phys. 44 (1973), 4869).

The papers by J. Robert and F. Clerc (SID 80 Digest Techn. Papers (1980), 30), J. Duchene (Displays 7 (1986), 3) and H. Schad (SID 82 Digest Techn. Papers (1982), 244) showed that liquid-crystalline phases must have high values for the ratio of the elastic constants K₃/K₁, high values for the optical anisotropy Δn and values for the dielectric anisotropy of Δε≤−0.5 in order to be suitable for use in high-information display elements based on the ECB effect. Electro-optical display elements based on the ECB effect have a homeotropic edge alignment (VA technology=vertically aligned) and, as so-called VAN (vertically aligned nematic) displays, for example in the MVA (multi-domain vertical alignment, for example: Yoshide, H. et al., paper 3.1: “MVA LCD for Notebook or Mobile PCs . . . ”, SID 2004 International Symposium, Digest of Technical Papers, XXXV, Book I, pp. 6 to 9, and Liu, C. T. et al., paper 15.1: “A 46-inch TFT-LCD HDTV Technology . . . ”, SID 2004 International Symposium, Digest of Technical Papers, XXXV, Book II, pp. 750 to 753), PVA (patterned vertical alignment, for example: Kim, Sang Soo, paper 15.4: “Super PVA Sets New State-of-the-Art for LCD-TV”, SID 2004 International Symposium, Digest of Technical Papers, XXXV, Book II, pp. 760 to 763), ASV (advanced super view, for example: Shigeta, Mitzuhiro and Fukuoka, Hirofumi, paper 15.2: “Development of High Quality LCDTV”, SID 2004 International Symposium, Digest of Technical Papers, XXXV, Book II, pp. 754 to 757) modes, have established themselves as one of the three more recent types of liquid-crystal display that are currently the most important, in particular for television applications, besides IPS (in-plane switching) displays (for example: Yeo, S. D., paper 15.3: “An LC Display for the TV Application”, SID 2004 International Symposium, Digest of Technical Papers, XXXV, Book II, pp. 758 & 759) and the long-known TN (twisted nematic) displays. The technologies are compared in general form, for example, in Souk, Jun, SID Seminar 2004, seminar M-6: “Recent Advances in LCD Technology”, Seminar Lecture Notes, M-6/1 to M-6/26, and Miller, Ian, SID Seminar 2004, seminar M-7: “LCD-Television”, Seminar Lecture Notes, M-7/1 to M-7/32.

Liquid-crystalline media which are particularly suitable for lighting devices for vehicles are disclosed, for example, in DE 102016011899 A1. They have positive dielectric anisotropy and are therefore not suitable for inorganic alignment layers which induce a homeotropic alignment.

The invention is based on the object of providing media having negative dielectric anisotropy, in particular for the above-mentioned liquid-crystal light valves for lighting devices for vehicles, which do not have the disadvantages indicated above or any do so to a lesser extent, and preferably at the same time have very high clearing points and low birefringence.

It has now been found that this object can be achieved if media according to the invention are used in liquid-crystal components.

The invention relates to a liquid-crystalline medium comprising, in a total concentration of 65% or more, one or more compounds from the group of the compounds of the formulae IA, IB, IC, ID and II

[chemical structure]

in which
R^{1A}, R^{1B},
R^{1C} and R² in each case, independently of one another, denote H, an alkyl or alkenyl radical having up to 15 C atoms which is unsubstituted, monosubstituted by CN or CF₃ or at least monosubstituted by halogen, where, in addition, one or more CH₂ groups in these radicals may be replaced by

[chemical structure]

—C≡C—, —O—, —S—, —CF₂O—, —OCF₂—, —OC—O— or —O—CO— in such a way that O atoms are not linked directly to one another,
R¹ and R^{1′} in each case, independently of one another, denote H or alkyl having 1 to 4 C atoms, preferably H or methyl, particularly preferably H,
A² denotes
   a) 1,4-cyclohexylene or 1,4-cyclohexenylene, in which one or two non-adjacent CH₂ groups may be replaced by —O— or —S—,
   b) 1,4-phenylene, in which one or two CH groups may be replaced by N and in which one or more H atoms may be replaced by F or Cl,
L¹ to L¹² in each case, independently of one another, denote F, CF₃, CHF₂ or Cl,
Z¹, Z¹ and Z² in each case, independently of one another, denote a single bond, —CH₂CH₂—, —CH═CH—, —CF₂O—, —OCF₂—, —CH₂O—, —OCH₂—, —COO—, —OCO—, —C₂F₄—, —CF═CF—, —C≡C—, —CH═CHCH₂O—,
a denotes 0 or 1,
p denotes 0, 1 or 2,
q denotes 0 or 1,
v denotes an integer from 1 to 7,
t denotes an integer from 1 to 7, and
(O) denotes a single bond or —O—,
where the clearing point of the medium is 120° C. or more.

In the present application, all atoms also include their isotopes. In particular, one or more hydrogen atoms (H) may be replaced by deuterium (D), which is particularly preferred in some embodiments; a high degree of deuteration enables or simplifies analytical determination of compounds, in particular in the case of low concentrations.

If a radical denotes an alkyl radical and/or an alkoxy radical, this may be straight-chain or branched. It is preferably straight-chain, has 2, 3, 4, 5, 6 or 7 carbon atoms and accordingly preferably denotes ethyl, propyl, butyl, pentyl, hexyl, heptyl, ethoxy, propoxy, butoxy, pentoxy, hexoxy or heptoxy, furthermore methyl, octyl, nonyl, decyl, undecyl, dodecyl, tridecyl, tetradecyl, pentadecyl, methoxy, octoxy, nonoxy, decoxy, undecoxy, dodecoxy, tridecoxy or tetradecoxy.

Oxaalkyl preferably denotes straight-chain 2-oxapropyl (=methoxymethyl), 2- (=ethoxymethyl) or 3-oxabutyl (=2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6- or 7-oxaoctyl, 2-, 3-, 4-, 5-, 6-, 7- or 8-oxanonyl, or 2-, 3-, 4-, 5-, 6-, 7-, 8- or 9-oxadecyl.

If a radical denotes an alkyl radical in which a CH₂ group has been replaced by —CH═CH—, this may be straight-chain or branched. It is preferably straight-chain and has 2 to 10 carbon atoms. Accordingly, it denotes, in particular, vinyl, prop-1- or -2-enyl, but-1-, -2- or -3-enyl, pent-1-, -2-, -3- or -4-enyl, hex-1-, -2-, -3-, -4- or -5-enyl, hept-1-, -2-, -3-, -4-, -5- or -6-enyl, oct-1-, -2-, -3-, -4-, -5-, -6- or -7-enyl, non-1-, -2-, -3-, -4-, -5-, -6-, -7- or -8-enyl, or dec-1-, -2-, -3-, -4-, -5-, -6-, -7-, -8- or -9-enyl.

If a radical denotes an alkyl radical in which one CH₂ group has been replaced by —O— and one has been replaced by —CO—, these are preferably adjacent. These thus contain an acyloxy group —CO—O— or an oxycarbonyl group —O—CO—. These are preferably straight-chain and have 2 to 6 carbon atoms. Accordingly, they denote, in particular, acetyloxy, propionyloxy, butyryloxy, pentanoyloxy, hexanoyloxy, acetyloxymethyl, propionyloxymethyl, butyryloxymethyl, pentanoyloxymethyl, 2-acetyloxyethyl, 2-propionyloxyethyl, 2-butyryloxyethyl, 2-acetyloxypropyl, 3-propionyloxypropyl, 4-acetyloxybutyl, methoxycarbonyl, ethoxycarbonyl, propoxycarbonyl, butoxycarbonyl, pentoxycarbonyl, methoxycarbonylmethyl, ethoxycarbonylmethyl, propoxycarbonylmethyl, butoxycarbonylmethyl, 2-(methoxycarbonyl)ethyl, 2-(ethoxycarbonyl)ethyl, 2-(propoxycarbonyl)ethyl, 3-(methoxycarbonyl)propyl, 3-(ethoxycarbonyl)propyl or 4-(methoxycarbonyl)butyl.

If a radical denotes an alkyl radical in which one CH₂ group has been replaced by unsubstituted or substituted —CH═CH— and an adjacent CH₂ group has been replaced by CO or CO—O or O—CO, this may be straight-chain or branched. It is preferably straight-chain and has 4 to 12 carbon atoms. Accordingly, it denotes, in particular, acryloyloxymethyl, 2-acryloyloxyethyl, 3-acryloyloxypropyl, 4-acryloyloxybutyl, 5-acryloyloxypentyl, 6-acryloyloxyhexyl, 7-acryloyloxyheptyl, 8-acryloyloxyoctyl, 9-acryloyloxynonyl, 10-acryloyloxydecyl, methacryloyloxymethyl, 2-methacryloyloxyethyl, 3-methacryloyloxypropyl, 4-methacryloyloxybutyl, 5-methacryloyloxypentyl, 6-methacryloyloxyhexyl, 7-methacryloyloxyheptyl, 8-methacryloyloxyoctyl or 9-methacryloyloxynonyl.

If a radical denotes an alkyl or alkenyl radical which is monosubstituted by CN or CF₃, this radical is preferably straight-chain. The substitution by CN or CF₃ is in any desired position.

If R denotes an alkyl or alkenyl radical which is at least monosubstituted by halogen, this radical is preferably straight-chain and halogen is preferably F or Cl. In the case of polysubstitution, halogen is preferably F. The resultant radicals also include perfluorinated radicals. In the case of monosubstitution, the fluorine or chlorine substituent can be in any desired position, but is preferably in the ω-position.

Compounds containing branched wing groups R may occasionally be of importance owing to better solubility in the conventional liquid-crystalline base materials, but in particular as chiral dopants if they are optically active. Smectic compounds of this type are suitable as components of ferroelectric materials

Branched groups of this type generally contain not more than one chain branch. Preferred branched radicals R are isopropyl, 2-butyl (=1-methylpropyl), isobutyl (=2-methylpropyl), 2-methylbutyl, isopentyl (=3-methylbutyl), 2-methylpentyl, 3-methylpentyl, 2-ethylhexyl, 2-propylpentyl, isopropoxy, 2-methylpropoxy, 2-methylbutoxy, 3-methylbutoxy, 2-methylpentoxy, 3-methylpentoxy, 2-ethylhexoxy, 1-methylhexoxy and 1-methylheptoxy.

If a radical represents an alkyl radical in which two or more CH₂ groups have been replaced by —O— and/or —CO—O—, this may be straight-chain or branched. It is preferably branched and has 3 to 12 carbon atoms. Accordingly, it denotes, in particular, biscarboxymethyl, 2,2-biscarboxyethyl, 3,3-biscarboxypropyl, 4,4-biscarboxybutyl, 5,5-biscarboxypentyl, 6,6-biscarboxyhexyl, 7,7-biscarboxyheptyl, 8,8-biscarboxyoctyl, 9,9-biscarboxynonyl, 10,10-biscarboxydecyl, bis(methoxycarbonyl)methyl, 2,2-bis(methoxycarbonyl)ethyl, 3,3-bis(methoxycarbonyl)propyl, 4,4-bis(methoxycarbonyl)butyl, 5,5-bis(methoxycarbonyl)pentyl, 6,6-bis(methoxycarbonyl)hexyl, 7,7-bis(methoxycarbonyl)heptyl, 8,8-bis(methoxycarbonyl)octyl, bis(ethoxycarbonyl)methyl, 2,2-bis(ethoxycarbonyl)ethyl, 3,3-bis(ethoxycarbonyl)propyl, 4,4-bis(ethoxycarbonyl)butyl or 5,5-bis(ethoxycarbonyl)pentyl.

The compounds of the formulae IA, IB, IC and ID are preferably selected from the following sub-formulae:

[chemical structure]

[chemical structure]

[chemical structure]

[chemical structure]

[chemical structure]

[chemical structure]

[chemical structure]

[chemical structure]

[chemical structure]

[chemical structure]

in which alkyl and alkyl* in each case, independently of one another, denote a straight-chain alkyl radical having 1-7 C atoms, in which one CH₂ group may be replaced by

[chemical structure]

and
(O) stands for —O— or a single bond.

Particularly preferred media according to the invention comprise one or more compounds of the formulae IA-2, IA-8, IA-14, IA-26, IA-28, IA-34, IA-40, IB-2, IB-11, IC-1 and ID-1, very particularly preferably IA-2, IA-8, IB-2, IB-11, IC-1 and ID-1.

In a very particularly preferred embodiment, the medium according to the invention comprises one or more compounds selected from the group of the compounds IA-8-1 to IA-8-10

[chemical structure]

The compounds of the formula II are preferably selected from the group of the compounds of the formulae

[chemical structure]

in which
alkyl and alkyl* in each case, independently of one another, denote a straight-chain alkyl radical having 1-7 C atoms, in which one CH₂ group may be replaced by

[chemical structure]

alkoxy and alkoxy* in each case, independently of one another, denote a straight-chain alkoxy radical having 1-7 C atoms, in which one CH₂ group may be replaced by,

[chemical structure]

and L¹¹ and L¹² have the meanings indicated above.

Preferably, L¹¹ and L¹² both denote F.

Particularly preferred compounds of the formula II are selected from the group of the compounds of the formula II-3a

[chemical structure]

in which alkoxy and alkoxy* denote unbranched alkoxy having 1 to 7 C atoms.

In a preferred embodiment, the medium according to the invention additionally comprises one or more compounds of the formulae III-1 to III-9,

[chemical structure]

in which
R³ in each case, independently of one another, has one of the meanings indicated for R^{1A} under formula IA, and
w and x in each case, independently of one another, denote 1 to 7,
(O) denotes a single bond or —O—.

R³ preferably denotes unbranched alkyl having 1 to 7 C atoms.

The medium according to the invention preferably comprises one or more compounds selected from the group of the compounds of the formulae IV-1 to IV-15

[chemical structure]

[chemical structure]

in which R⁴¹ and R⁴² have the meanings indicated for R^{1A}. Preferably, R⁴¹ and R⁴² in each case, independently of one another, denote straight-chain alkyl or alkenyl having 1 to 7 C atoms, alternatively R⁴² also denotes alkoxy having 1 to 7 C atoms.

The medium preferably comprises one or more compounds of the formula IV-10.

In a further preferred embodiment, the medium according to the invention comprises one or more compounds selected from the group of the compounds of the formulae V-1 to V-4

[chemical structure]

in which R⁵¹ and R⁵² have the meanings indicated for R^{1A}. Preferably, R⁵¹ and R⁵² in each case, independently of one another, denote straight-chain alkyl or alkenyl having up to 7 C atoms, R⁵² alternatively denotes alkoxy having 1 to 7 C atoms.

The invention furthermore also relates to electro-optical components, in particular light valves, based on the ECB effect, having two plane-parallel outer plates, which, with a frame, form a cell, integrated non-linear elements for switching individual pixels on the outer plates, and a nematic liquid-crystal mixture having negative dielectric anisotropy and high resistivity located in the cell, which contain the media according to the invention, and to the use of these media for electro-optical purposes.

The invention furthermore relates to the use of the electro-optical components according to the invention in lighting devices for vehicles and in liquid-crystal displays, in particular VA, IPS and FFS displays.

The invention furthermore relates to lighting devices for vehicles and to electro-optical displays which contain these components.

The construction of the light valves according to the invention from polarisers, electrode base plates and surface-treated electrodes corresponds to the usual design for components of this type. The term usual design is broadly drawn here and also encompasses all derivatives and modifications of the components, in particular also matrix display elements based on poly-Si TFTs or MIMs.

A vehicle lighting device according to the invention has at least one light source. This light source emits light, so that furthermore at least one screen device for influencing the light emitted by the light source is provided. The screen device is in the form of an LCD screen and accordingly has at least one liquid-crystal light valve, which can be transilluminated from the back. In a lighting device according to the invention, the light source can have a very wide variety of designs. It can have one or more lamps. Suitable lamps are, for example, conventional lamps in the form of incandescent bulbs or gas-discharge lamps. For the purposes of the present invention, modern lamps, for example LEDs, are also conceivable as lamps for the light source, as are, in particular, also the cold cathode lamps (CCFLs) used for liquid-crystal displays. The individual lamps can be arranged differently, for example in a matrix-like manner. One or more arrangements of further optical components in the light source or in the lighting device may of course bring advantages. These can be, for example, one or more reflectors or one or more lenses.

It is likewise advantageous if the liquid-crystal light valve in a lighting device according to the invention has a first polariser, through which the light provided by the light source ingresses. Furthermore, a second polariser is provided, through which the light leaves the liquid-crystal light valve. A layer comprising the liquid-crystal medium according to the invention is arranged between the first polariser and the second polariser. This liquid-crystal layer serves to rotate the plane of polarisation of the light passing through this liquid-crystal layer as a function of an applied voltage. Depending on the type of design of the liquid-crystal layer, this liquid-crystal layer may effect rotation of the polarisation of the light in the electric field or prevent this rotation function of the light passing through. In an embodiment of this type, the liquid-crystal light valve and in particular the first polariser are designed to be temperature-resistant up to about 200° C. This is important, in particular, in the case of the first polariser, since this absorbs up to about 50% of the light emitted by the light source and the associated energy. The various designs of the polarisers in connection with the alignment of the liquid-crystal molecules in the liquid-crystal layer essentially correspond to those that are used in liquid-crystal displays and are known to the person skilled in the art. In principle, all known configurations are suitable, and preference is given to liquid-crystal light valves of the VA, IPS or FFS type, particularly preferably of the VA type.

The liquid-crystal mixtures according to the invention facilitate a significant broadening of the available parameter latitude. The achievable combinations of clearing point, phase width, viscosity at low temperature, thermal and UV stability and dielectric anisotropy are far superior to previous materials from the prior art.

It goes without saying that, through a suitable choice of the components of the mixtures according to the invention, it is also possible for higher clearing points (for example above 150° C.) to be achieved at higher threshold voltages or lower clearing points to be achieved at lower threshold voltages with retention of the other advantageous properties. At viscosities correspondingly increased only slightly, it is likewise possible to obtain mixtures having greater Δε and thus low thresholds.

The liquid-crystal mixtures according to the invention enable a clearing point of 120° C. or more, preferably of 130° C. or more, particularly preferably of 135° C. or more and very particularly preferably of 140° C. or more, to be achieved in an advantageous manner while retaining the nematic phase down to −20° C. and preferably to −30° C., particularly preferably to −40° C.

The nematic phase range is preferably at least 140 K, particularly preferably at least 160 K, in particular at least 180 K. This range preferably extends at least from −40° to +140°.

The lower limit of the nematic phase range is the temperature at which a transition from the nematic phase to another liquid-crystalline phase, for example a smectic phase, or crystallisation occurs on cooling from the nematic phase. In the case of the mixtures according to the invention, this is at ≤−20° C., preferably at ≤−30° C., particularly preferably at ≤−40° C.

The upper limit of the nematic phase range is the temperature at which a transition from the nematic phase to the isotropic liquid phase (clearing point) is observed on warming from the nematic phase. In the case of the mixtures according to the invention, this is at ≥120° C., preferably at ≥130° C., particularly preferably at ≥140° C. and very particularly preferably at ≥145° C.

The liquid-crystal mixtures according to the invention have a dielectric anisotropy Δε of −2.0 or less, preferably −3.0 or less and particularly preferably of −4.0 or less.

The liquid-crystal mixtures according to invention have a dielectric anisotropy Δε in the range from −2.5 to −8.0, preferably from −3.5 to −7.0, particularly preferably from −4.0 to −6.0.

The liquid-crystal mixtures according to invention enable a high value to be achieved for the resistivity, enabling excellent light valves according to the invention to be achieved. In particular, the mixtures are distinguished by low operating voltages.

The liquid-crystal mixtures according to invention have an optical anisotropy (Δn) in the range from 0.050 to 0.200, preferably from 0.080 to 0.190, particularly preferably from 0.100 to 0.180.

The rotational viscosity γ₁ of the mixtures according to the invention at 20° C. is preferably <350 mPa·s, particularly preferably <300 mPa·s.

Further preferred embodiments are indicated below, where compounds and compound classes are indicated by means of acronyms. The meaning of these acronyms is evident from Tables 1 to 3 and Table A shown below. The preferred embodiments are preferred individually or in combination with one another.
The medium comprises one or more compounds selected from the group of the compounds of the formulae IA, IB, IC, ID and II in a total concentration in the range from 65% to 90%, preferably from 68% to 85%, very particularly preferably from 70% to 80%.
The medium comprises one or more compounds selected from the group of the compounds of the formulae IA, IB, IC, ID and II and IV-2 to IV-8 and V-1 to V-4 in a total concentration in the range from 80% to 100%, preferably from 85% to 98%, very particularly preferably from 90% to 95%.
The medium comprises one or more compounds of the formula IV-1 in a total concentration from more than 0% to 20%, preferably in the range from 0.5% to 18%, particularly preferably in the range from 2% to 16%.
The medium comprises no compound IV-1 or IV-9.
The medium comprises one or more compounds of the formula IV-1 in a total concentration of 20% or less, preferably of 16% or less, particularly preferably of 10% or less and very particularly preferably of 5% or less.
The medium comprises one or more compounds of the formula IV-1 and/or IV-9 in a total concentration of 20% or less, preferably of 16% or less, particularly preferably of 10% or less and very particularly preferably of 5% or less.
The medium comprises one or more compounds CC-n-V, in particular CC-3-V and/or CC-4-V, in a total concentration of 5% or less.
The medium comprises one or more compounds selected from the compounds from the group CCH-nm, CC-n-Vm and CC-n-mV1 in a total concentration of 5% or less, preferably 3% or less and particularly preferably 1% or less, in particular in the range from 0.01% to 0.5%.
The medium comprises one or more compounds of the formula IA-2 in a total concentration from more than 0% to 30%, preferably in the range from 0.5% to 25%, particularly preferably in the range from 5% to 20%.
The medium comprises one or more compounds selected from the group of the compounds of the formulae IA-2 and IV-1 in a total concentration in the range from 5% to 40%, preferably in the range from 7% to 35%, particularly preferably in the range from 10% to 30%.
The medium comprises one, two or more compounds of the formula II-3a, particularly preferably the compounds B(S)-2O—O4 and B(S)-2O—O5, in a total concentration from 5% to 25%, preferably from 10% to 20%, particularly preferably from 12% to 16%.
The medium comprises two or more compounds of the formula IC-1 in a total concentration of 20% or mehr.
The medium comprises one or more compounds selected from the group of the compounds of the formulae V-1, V-2, V-3 and V-4, preferably V-3 and V-4, in a total concentration in the range from 8% to 25%.
The medium comprises two, three or more compounds of the formula V-3 in a total concentration in the range from 5% to 20%, particularly preferably from 7% to 15%, very particularly preferably from 9% to 12%.
The medium comprises two, three or more compounds of the formula V-4 in a total concentration in the range from 5% to 20%, particularly preferably from 7% to 12%, very particularly preferably from 8% to 10%.
The medium comprises two, three or more compounds selected from the group of the compounds of the formula IA-8 and two, three, four or more compounds selected from the group of the compounds of the formulae V-3 and V-4.
The medium comprises one or more compounds of the formulae IV-14 and/or IV-15 in a total concentration in the range from 2% to 20%, particularly preferably from 5% to 15%, very particularly preferably from 8% to 10%.

The liquid-crystal mixtures that can be used in accordance with the invention are prepared in a manner conventional per se. In general, the desired amount of the components used in the lesser amount is dissolved in the components making up the principal constituent, advantageously at elevated temperature. It is also possible to mix solutions of the components in an organic solvent, for example in acetone, chloroform or methanol, and to remove the solvent again, for example by distillation, after thorough mixing.

The dielectrics may also comprise further additives known to the person skilled in the art and described in the literature. For example, 0-15% of pleochroic dyes or chiral dopants can be added.

C denotes a crystalline phase, S a smectic phase, Sc a smectic C phase, N a nematic phase and I the isotropic phase.

V₁₀ denotes the voltage for 10% transmission (viewing direction perpendicular to the plate surface). tₒₙ denotes the switch-on time and t_{off} the switch-off time at an operating voltage corresponding to 2.0 times the value of V₁₀. An denotes the optical anisotropy and no denotes the refractive index. Δε denotes the dielectric anisotropy (Δε=ε_{∥}−ε_{⊥}, where E_{∥} denotes the dielectric constant parallel to the longitudinal molecular axes and ε_{⊥} denotes the dielectric constant perpendicular thereto). The electro-optical data were measured in a TN cell at the 1st minimum (i.e. at a d·Δn value of 0.5) at 20° C., unless expressly stated otherwise. The optical data were measured at 20° C., unless expressly indicated otherwise.

Throughout the patent application, 1,4-cyclohexylene rings and 1,4-phenylene rings are depicted as follows:

[chemical structure]

The cyclohexylene rings are trans-1,4-cyclohexylene rings.

Throughout the patent application, (O)alkyl or (O)-alkyl, or (O)alkyl* or (O)-alkyl*, denote either Oalkyl (alkoxy) or alkyl, or Oalkyl* (alkoxy*) or alkyl* respectively. Furthermore throughout the patent application, (O)alkenyl or (O)-alkenyl, or (O)alkenyl* or (O)-alkenyl*, denote either Oalkenyl (alkenyloxy) or alkenyl, or Oalkenyl* (alkenyloxy*) or alkenyl* respectively.

Throughout the patent application and in the working examples, the structures of the liquid-crystal compounds are indicated by means of acronyms. Unless indicated otherwise, the transformation into chemical formulae is carried out in accordance with Tables 1-3. All radicals CₙH₂ₙ₊₁, CₘH₂ₘ₊₁ and Cₘ·H_{2m′+1} or CₙH₂ₙ and CₘH₂ₘ are straight-chain alkyl radicals or alkylene radicals respectively, in each case having n, m, m′ or z C atoms respectively. n, m, m′ and z in each case, independently of one another, denote 1, 2, 3, 4, 5, 6, 7, 8, 9, 10, 11 or 12, preferably 1, 2, 3, 4, 5 or 6. Table 1 shows the codes for the ring elements of the respective compound, Table 2 lists the bridging members and Table 3 indicates the meanings of the symbols for the left-hand or right-hand side chains of the compounds.

TABLE 1
Ring elements

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

TABLE 2
Bridging members

| E | —CH₂CH₂— | | |
|---|---|---|---|
| V | —CH=CH— | | |
| T | —C≡C— | | |
| W | —CF₂CF₂— | | |
| Z | —COO— | Zl | —OCO— |
| O | —CH₂O— | Ol | —OCH₂— |
| Q | —CF₂O— | Ql | —OCF₂— |

TABLE 3
Side chains

| Left-hand side chain | | Right-hand side chain | |
|---|---|---|---|
| n- | CₙH_{2n+1—} | -n | —CₙH₂ₙ₊₁ |
| nO- | CₙH₂ₙ₊₁—O— | -On | —O—CₙH₂ₙ₊₁ |
| V— | CH₂═CH— | —V | —CH═CH₂ |
| nV- | CₙH₂ₙ₊₁—CH=CH— | -nV | —CₙH₂ₙ—CH═CH₂ |
| Vn- | CH₂═CH— CₙH₂ₙ— | -Vn | —CH═CH—CₙH₂ₙ₊₁ |
| nVm- | CₙH₂ₙ₊₁—CH═CH—CₘH₂ₘ— | -nVm | —CₙH₂ₙ—CH═CH—CₘH₂ₘ₊₁ |
| N— | N≡C— | —N | —C≡N |
| F— | F— | —F | —F |
| Cl— | Cl— | —Cl | —Cl |
| M- | CFH₂— | -M | —CFH₂ |
| D- | CF₂H— | -D | —CF₂H |
| T- | CF₃— | -T | —CF₃ |
| MO- | CFH₂O— | -OM | —OCFH₂ |
| DO- | CF₂HO— | -OD | —OCF₂H |
| TO- | CF₃O— | -OT | —OCF₃ |
| T- | CF₃— | -T | —CF₃ |
| A- | H—C≡C— | -A | —C≡C—H |

Besides one or more compounds selected from the group of the compounds of the formulae IA, IB, IC, ID and II, the mixtures according to the invention preferably comprise one or more of the compounds of the compounds from Table A indicated below.

TABLE A

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

The following abbreviations are used:

(n, m, m′, z: in each case, independently of one another, 1, 2, 3, 4, 5 or 6; (O)CₘH₂ₘ₊₁ means OCₘH₂ₘ₊₁ or CₘH₂ₘ₊₁)

The liquid-crystalline media according to the invention preferably comprise one or more compounds from Table A.

The media may also comprise further additives known to the person skilled in the art and described in the literature, such as, for example, UV absorbers, antioxidants, nanoparticles and free-radical scavengers. For example, 0-15% of pleochroic dyes, stabilisers, such as, for example, phenols, HALS (hindered amine light stabilizers), for example Tinuvin 770 (=bis(2,2,6,6-tetramethyl-4-piperidyl) sebacate), or chiral dopants may be added. Suitable stabilisers for the mixtures according to the invention are, in particular, those listed in Table B.

For example, it is possible to add 0-15% of pleochroic dyes, furthermore conductive salts, preferably ethyldimethyldodecylammonium 4-hexoxybenzoate, tetrabutylammonium tetraphenylboranate or complex salts of crown ethers (cf., for example, Haller et al., Mol. Cryst. Liq. Cryst., Volume 24, pages 249-258 (1973)), for improving the conductivity or substances for modifying the dielectric anisotropy, the viscosity and/or the alignment of the nematic phases. Substances of this type are described, for example, in DE-A 22 09 127, 22 40 864, 23 21 632, 23 38 281, 24 50 088, 26 37 430 and 28 53 728.

TABLE B

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

Table B shows possible dopants which can be added to the mixtures according to the invention. If the mixtures comprise a dopant, it is added in amounts of 0.01-4% by weight, preferably 0.01-3% by weight.

TABLE C

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

Stabilisers which can be added, for example, to the mixtures according to the invention in amounts of 0-10% by weight, preferably 0.001-5% by weight, in particular 0.001-1% by weight, are shown below.

### WORKING EXAMPLES

The following examples are intended to explain the invention without limiting it. In the examples, m.p. denotes the melting point and C denotes the clearing point of a liquid-crystalline substance in degrees Celsius; boiling temperatures are denoted by m.p. Furthermore: C denotes crystalline solid state, S denotes smectic phase (the index denotes the phase type), N denotes nematic state, Ch denotes cholesteric phase, I denotes isotropic phase, T_{g} denotes glass-transition temperature. The number between two symbols indicates the conversion temperature in degrees Celsius an.

The host mixture used for determination of the optical anisotropy Δn of the compounds of the formula IA is the commercial mixture ZLI-4792 (Merck KGaA). The dielectric anisotropy Δε is determined using commercial mixture ZLI-2857. The physical data of the compound to be investigated are obtained from the change in the dielectric constants of the host mixture after addition of the compound to be investigated and extrapolation to 100% of the compound employed. In general, 10% of the compound to be investigated are dissolved in the host mixture, depending on the solubility.

Unless indicated otherwise, parts or percent data denote parts by weight or percent by weight.

Above and below:
Vₒ denotes threshold voltage, capacitive [V] at 20° C.,
nₑ denotes extraordinary refractive index at 20° C. and 589 nm,
nₒ denotes ordinary refractive index at 20° C. and 589 nm,
Δn denotes optical anisotropy at 20° C. and 589 nm,
ε_{⊥} denotes dielectric permittivity perpendicular to the director at 20° C. and 1 kHz,
ε_{∥} denotes dielectric permittivity parallel to the director at 20° C. and 1 kHz,
Δε denotes dielectric anisotropy at 20° C. and 1 kHz,
cl.p., T(N,I) denotes clearing point [° C.],
γ₁ denotes rotational viscosity measured at 20° C. [mPa·s], determined by the rotation method in a magnetic field,
   K₁ denotes elastic constant, “splay” deformation at 20° C. [pN],
   K₂ denotes elastic constant, “twist” deformation at 20° C. [pN],
   K₃ denotes elastic constant, “bend” deformation at 20° C. [pN],
   LTS denotes low-temperature stability (nematic phase), determined in test cells.

Unless explicitly noted otherwise, all values indicated in the present application for temperatures, such as, for example, the melting point T(C,N), the transition from the smectic (S) to the nematic (N) phase T(S,N) and the clearing point T(N,I), are indicated in degrees Celsius (° C.). M.p. denotes melting point, cl.p.=clearing point. Furthermore, Tg=glass state, C=crystalline state, N=nematic phase, S=smectic phase and I=isotropic phase. The numbers between these symbols represent the transition temperatures.

The term “threshold voltage” for the present invention relates to the capacitive threshold (V₀), also called the Freedericksz threshold, unless explicitly indicated otherwise. In the examples, as is generally usual, the optical threshold can also be indicated for 10% relative contrast (V₁₀).

The display used for measurement of the capacitive threshold voltage consists of two plane-parallel glass outer plates at a separation of 20 μm, which each have on the insides an electrode layer and an unrubbed polyimide alignment layer on top, which cause a homeotropic edge alignment of the liquid-crystal molecules.

The display or test cell used for measurement of the tilt angle consists of two plane-parallel glass outer plates at a separation of 4 μm, which each have on the insides an electrode layer and a polyimide alignment layer on top, where the two polyimide layers are rubbed antiparallel to one another and cause a homeotropic edge alignment of the liquid-crystal molecules.

The polymerisable compounds are polymerised in the display or test cell by irradiation with UVA light (usually 365 nm) of a defined intensity for a pre-specified time, with a voltage simultaneously being applied to the display (usually 10 V to 30 V alternating current, 1 kHz). In the examples, unless indicated otherwise, a 50 mW/cm² mercury vapour lamp is used, and the intensity is measured using a standard UV meter (make Ushio UNI meter) fitted with a 365 nm band-pass filter.

The tilt angle is determined by a rotational crystal experiment (Autronic-Melchers TBA-105). A low value (i.e. a large deviation from the 90° angle) corresponds to a large tilt here.

The VHR value is measured as follows: 0.3% of a polymerisable monomeric compound are added to the LC host mixture, and the resultant mixture is introduced into TN-VHR test cells (rubbed at 90°, alignment layer TN polyimide, layer thickness d≈6 μm). The HR value is determined after 5 min at 100° C. before and after UV exposure for 2 h (sun test) at 1 V, 60 Hz, 64 μs pulse (measuring instrument: Autronic-Melchers VHRM-105).

In order to investigate the low-temperature stability, also known as “LTS”, i.e. the stability of the LC mixture to spontaneous crystallisation-out of individual components at low temperatures, bottles containing 1 g of liquid-crystal mixture are stored at the temperature indicated, for example −20° C., and it is regularly checked whether the mixtures have crystallised out.

Unless explicitly noted otherwise, all concentrations in the present application are indicated in percent by weight and relate to the corresponding mixture as a whole, comprising all solid or liquid-crystalline components, without solvents. All physical properties are determined in accordance with “Merck Liquid Crystals, Physical Properties of Liquid Crystals”, Status November 1997, Merck KGaA, Germany, and apply for a temperature of 20° C., unless explicitly indicated otherwise.

Owing to the surprisingly high clearing points and excellent LTS, the following mixture examples having negative dielectric anisotropy are suitable, in particular, for light valves for lighting devices for motor vehicles which have at least one homeotropic alignment layer and for VA displays.

In addition, they are suitable for light valves and liquid-crystal displays having a planar alignment which are based on the IPS or FFS effect.

### MIXTURE EXAMPLES

### Example M1

| | | | |
|---|---|---|---|
| CCY-3-O2 | 6.0% | T_{(N, I)} [° C.]: | 124.5 |
| CCY-3-O3 | 6.0% | Δn (20° C., 589.3 nm): | 0.1595 |
| CCY-4-O2 | 6.0% | Δε (20° C., 1 kHz): | −5.3 |
| CPY-2-O2 | 12.0% | | |
| CPY-3-O2 | 12.0% | K₁ (20° C.) [pN]: | 30.8 |
| PYP-2-3 | 10.0% | K₃ (20° C.) [pN]: | 39.6 |
| PYP-2-4 | 10.0% | | |
| CCH-34 | 10.0% | V₀ (20° C.) [V] | 2.89 |
| CCH-35 | 6.0% | | |
| CCP-3-1 | 8.0% | | |
| B(S)-2O-O4 | 7.0% | | |
| B(S)-2O-O5 | 7.0% | | |

### Example M2

| | |
|---|---|
| CCY-3-O2 | 6.0% |
| CCY-3-O3 | 6.0% |
| CCY-4-O2 | 6.0% |
| CPY-2-O2 | 14.0% |
| CPY-3-O2 | 14.0% |
| CCH-34 | 10.0% |
| CCH-35 | 6.0% |
| CCP-3-1 | 8.0% |
| BCH-32 | 8.0% |
| BCH-52 | 8.0% |
| B(S)-2O-O4 | 7.0% |
| B(S)-2O-O5 | 7.0% |

### Example M3

| | | | |
|---|---|---|---|
| CY-3-O4 | 16.0% | T_{(N, I)} [° C.]: | 137.2 |
| CY-5-O4 | 7.0% | Δn (20° C., 589.3 nm): | 0.1480 |
| CCY-3-O2 | 6.0% | | |
| CCY-3-O3 | 6.0% | | |
| CCY-4-O2 | 6.0% | K₁ (20° C.) [pN]: | 22.1 |
| CPY-2-O2 | 12.0% | K₃ (20° C.) [pN]: | 24.3 |
| CPY-3-O2 | 12.0% | | |
| CCP-3-1 | 8.0% | V₀ (20° C.) [V] | 2.08 |
| CBC-33F | 3.0% | | |
| CBC-53F | 6.0% | | |
| CPGP-5-2 | 4.0% | | |
| CPGP-5-3 | 4.0% | | |
| B(S)-2O-O4 | 5.0% | | |
| B(S)-2O-O5 | 5.0% | | |

### Example M4

| | | | |
|---|---|---|---|
| CY-3-O4 | 20.0% | T_{(N, I)} [° C.]: | 143.2 |
| CCY-3-O2 | 6.0% | Δn (20° C., 589.3 nm): | 0.1524 |
| CCY-3-O3 | 6.0% | Δε (20° C., 1 kHz): | −4.6 |
| CCY-4-O2 | 6.0% | | |
| CPY-2-O2 | 12.0% | K₁ (20° C.) [pN]: | 21.9 |
| CPY-3-O2 | 12.0% | K₃ (20° C.) [pN]: | 24.2 |
| CCH-34 | 5.0% | | |
| CCP-3-1 | 8.0% | V₀ (20° C.) [V] | 2.43 |
| CBC-33F | 3.0% | | |
| CBC-53F | 6.0% | | |
| CPGP-5-2 | 5.0% | | |
| CPGP-5-3 | 5.0% | | |
| PGIY-2-O4 | 6.0% | | |

### Example M5

| | | | |
|---|---|---|---|
| CY-3-O2 | 4.0% | T_{(N, I)} [° C.]: | 122.0 |
| CY-3-O4 | 8.0% | Δn (20° C., 589.3 nm): | 0.1778 |
| CCY-3-O2 | 6.0% | Δε (20° C., 1 kHz): | −4.1 |
| CCY-3-O3 | 6.0% | | |
| CCY-4-O2 | 6.0% | K₁ (20° C.) [pN]: | 19.1 |
| CPY-2-O2 | 12.0% | K₃ (20° C.) [pN]: | 21.1 |
| CPY-3-O2 | 12.0% | | |
| PYP-2-3 | 12.0% | V₀ (20° C.) [V] | 2.08 |
| PYP-2-4 | 12.0% | | |
| CC-4-V | 3.0% | LTS (−30° C.) [h] | 1000 |
| CCP-V-1 | 9.0% | LTS (−40° C.) [h] | 600 |
| CPTP-301 | 5.0% | | |
| PTP-102 | 5.0% | | |

### Example M6

| | | | |
|---|---|---|---|
| CY-3-O2 | 20.0% | T_{(N, I)} [° C.]: | 137.3 |
| CY-5-O4 | 9.0% | Δn (20° C., 589.3 nm): | 0.1382 |
| CCY-3-O2 | 6.0% | Δε (20° C., 1 kHz): | −4.8 |
| CCY-3-O3 | 6.0% | | |
| CCY-4-O2 | 6.0% | K₁ (20° C.) [pN]: | 21.0 |
| CPY-2-O2 | 12.0% | K₃ (20° C.) [pN]: | 24.2 |
| CPY-3-O2 | 12.0% | | |
| CCP-3-1 | 8.0% | V₀ (20° C.) [V] | 2.37 |
| CBC-33F | 4.0% | | |
| CBC-53F | 7.0% | LTS (−30° C.) [h] | 1008 |
| CPGP-5-2 | 5.0% | | |
| CPGP-5-3 | 5.0% | | |

### Example M7

| | | | |
|---|---|---|---|
| CY-3-O2 | 8.0% | T_{(N, I)} [° C.]: | 134.7 |
| CY-5-O4 | 8.0% | Δn (20° C., 589.3 nm): | 0.1623 |
| CCY-3-O2 | 6.0% | Δε (20° C., 1 kHz): | −4.5 |
| CCY-3-O3 | 6.0% | | |
| CCY-4-O2 | 6.0% | K₁ (20° C.) [pN]: | 20.9 |
| CPY-2-O2 | 12.0% | K₃ (20° C.) [pN]: | 22.9 |
| CPY-3-O2 | 12.0% | | |
| PYP-2-3 | 12.0% | V₀ (20° C.) [V] | 2.39 |
| PYP-2-4 | 12.0% | | |
| CCP-3-1 | 8.0% | LTS (−20° C.) [h] | 744 |
| CBC-33F | 4.0% | LTS(−40° C.) [h] | 600 |
| CBC-53F | 6.0% | | |

### Example M8

| | | | |
|---|---|---|---|
| CY-3-O4 | 8.0% | T_{(N, I)} [° C.]: | 138.0 |
| CY-5-O4 | 8.0% | Δn (20° C., 589.3 nm): | 0.1610 |
| CCY-3-O2 | 6.0% | Δε (20° C., 1 kHz): | −4.4 |
| CCY-3-O3 | 6.0% | | |
| CCY-4-O2 | 6.0% | K₁ (20° C.) [pN]: | 21.0 |
| CPY-2-O2 | 12.0% | K₃ (20° C.) [pN]: | 23.8 |
| CPY-3-O2 | 12.0% | | |
| PYP-2-3 | 10.0% | V₀ (20° C.) [V] | 2.45 |
| PYP-2-4 | 12.0% | | |
| CCP-3-1 | 8.0% | LTS(−30° C.) [h] | 528 |
| CBC-33F | 5.0% | LTS(−40° C.) [h] | 384 |
| CBC-53F | 7.0% | | |

### Example M9

| | | | |
|---|---|---|---|
| CY-3-O4 | 7.0% | T_{(N, I)} [°C.]: | 149.5 |
| CCY-3-O2 | 6.0% | Δn (20° C., 589.3 nm): | 0.1754 |
| CCY-3-O3 | 6.0% | Δε (20° C., 1 kHz): | −3.6 |
| CCY-4-O2 | 6.0% | | |
| CPY-2-O2 | 12.0% | K₁ (20° C.) [pN]: | 22.2 |
| CPY-3-O2 | 12.0% | K₃ (20° C.) [pN]: | 25.5 |
| PYP-2-3 | 10.0% | | |
| PYP-2-4 | 10.0% | V₀ (20° C.) [V] | 2.81 |
| CC-4-V | 3.0% | | |
| CCP-V-1 | 9.0% | LTS (−30° C.) [h] | 1450 |
| CPTP-301 | 5.0% | LTS (−40° C.) [h] | 240 |
| PTP-102 | 3.0% | | |
| CBC-33F | 4.0% | | |
| CBC-53F | 7.0% | | |

### Example M10

| | | | |
|---|---|---|---|
| BCH-32 | 9.0% | T_{(N, I)} [° C.]: | 132.2 |
| CBC-33 | 1.5% | Δn (20° C., 589.3 nm): | 0.1674 |
| CBC-33F | 3.0% | | |
| CBC-53F | 1.5% | | |
| CCP-3-1 | 3.5% | | |
| CCY-3-O1 | 2.0% | | |
| CCY-3-O2 | 6.0% | | |
| CCY-3-O3 | 5.5% | | |
| CCY-4-O2 | 6.0% | | |
| CCY-5-O2 | 6.0% | | |
| CPY-2-O2 | 9.0% | | |
| CPY-3-O2 | 9.0% | | |
| CY-3-O4 | 3.0% | | |
| CY-5-O4 | 5.0% | | |
| PY-1-O4 | 3.5% | | |
| PY-4-O2 | 3.5% | | |
| PYP-2-3 | 11.5% | | |
| PYP-2-4 | 11.5% | | |

### Example M11

Example M11 consists of 91.84% of the medium from Example M10, 8.0% of the reactive mesogen RM-1 and 0.16% of the photoinitiator Irgacure 907®. This medium is suitable, in particular, for the production of light valves of the PDLC type.

[chemical structure]

1. Liquid-crystalline medium, characterised in that it comprises one or more compounds, in a total concentration of 65% or more, selected from the group of the compounds of the formulae IA, IB, IC, ID and II [chemical structure]
in which
R^{1A}, R^{1B}, R^{1C} and R² in each case, independently of one another, denote H, an alkyl or alkenyl radical having up to 15 C atoms which is unsubstituted, monosubstituted by CN or CF₃ or at least monosubstituted by halogen, where, in addition, one or more CH₂ groups in these radicals may be replaced by [chemical structure]
—C≡C—, —O—, —S—, —CF₂O—, —OCF₂—, —OC— or —O—CO— in such a way that O atoms are not linked directly to one another,
R¹ and R^{1′} in each case, independently of one another, denote H or alkyl having 1 to 4 C atoms,
A² denotes
a) 1,4-cyclohexylene or 1,4-cyclohexenylene, in which one or two non-adjacent CH₂ groups may be replaced by —O— or —S—,
b) 1,4-phenylene, in which one or two CH groups may be replaced by N and in which one or more H atoms may be replaced by F or Cl,
L¹ to L¹² in each case, independently of one another, denote F, CF₃, CHF₂ or Cl,
Z¹, Z^{1′} and Z² in each case, independently of one another, denote a single bond, —CH₂CH₂—, —CH═CH—, —CF₂O—, —OCF₂—, —CH₂O—, —OCH₂—, —COO—, —OCO—, —C₂F₄—, —CF═CF—, —C≡C—, —CH═CHCH₂O—,
a denotes 0 or 1,
p denotes 0, 1 or 2,
q denotes 0 or 1,
v denotes an integer from 1 to 7,
t denotes an integer from 1 to 7, and
(O) denotes a single bond or —O—,
and furthermore characterised in that the clearing point of the medium is 120° C. or more.

2. Medium according to claim 1, where the medium comprises one or more compounds selected from the group of the compounds of the formulae [chemical structure] [chemical structure]
in which
alkyl and alkyl* in each case, independently of one another, denote a straight-chain alkyl radical having 1-7 C atoms, in which one CH₂ group may be replaced by [chemical structure]
and
(O) stands for —O— or a single bond.

3. Medium according to claim 1, where the medium comprises one or more compounds selected from the group of the compounds of the formulae [chemical structure]
in which
L¹¹ and L¹² have the meanings indicated in claim 1, and alkyl and alkyl* in each case, independently of one another, denote a straight-chain alkyl radical having 1-7 C atoms, in which one CH₂ group may be replaced by [chemical structure]
and
alkoxy and alkoxy* in each case, independently of one another, denote a straight-chain alkoxy radical having 1-7 C atoms, in which one CH₂ group may be replaced by

[chemical structure]

4. Medium according to claim 1, where the medium additionally comprises one or more compounds of the formula [chemical structure]
in which
R⁴¹ and R⁴² in each case, independently of one another, denote straight-chain alkyl or alkenyl having 1 to 7 C atoms, alternatively R⁴² also denotes alkoxy having 1 to 7 C atoms,
in a total concentration of 20% or less.

5. Medium according to claim 1, where the medium additionally comprises one or more compounds of the formulae [chemical structure]
in which
R⁵¹ and R⁵² in each case, independently of one another, denote straight-chain alkyl or alkenyl having up to 7 C atoms, R⁵² alternatively denotes alkoxy having 1 to 7 C atoms.

6. (canceled)

7. (canceled)

8. Process for the preparation of a medium according to claim 1, characterised in that one or more compounds selected from the group of the compounds of the formulae IA, IB, IC, ID and II are mixed with one another, where one or more additives are optionally added.

9. Electro-optical component containing a liquid-crystalline medium according to claim 1.

10. Electro-optical component according to claim 9, where the component is a transmissive liquid-crystal light valve.

11. Electro-optical component according to claim 9, where the component is a reflective liquid-crystal light valve.

12. Electro-optical component according to claim 11 of the LCoS type.

13. Lighting device for vehicles comprising an electro-optical component according to claim 9.

14. Liquid-crystal display comprising an electro-optical component according to claim 9.

15. The lighting device of claim 13, which comprises a liquid-crystal light valve comprising the liquid-crystalline medium.
